(19) United States
(12) Patent Application Publication
(10) Pub. No.: US 2020/0398234 A1
(43) Pub. Date: Dec. 24, 2020

(54) MIXING DEVICE

(71) Applicant: AVL LIST GmbH, Graz (AT)

(72) Inventor: Karl-Heinz Schäfer, Graz (AT)

(21) Appl. No.: 16/975,702

(22) PCT Filed: Feb. 26, 2019
(86) PCT No.: PCT/AT2019/060062

§ 371 Date: Aug. 25, 2020

(30) Foreign Application Priority Data
Feb. 26, 2018 (AT) A 50166/2018

(51) Int. Cl. B01F 5/04; B01F 3/04; B01F 5/06; F01N 3/20; F01N 3/28; F01N 13/08

(52) U.S. Cl. CPC B01F 5/0451; B01F 3/04049; B01F 5/0655; B01F 2005/0022; F01N 3/2066; F01N 3/2892; F01N 13/08; B01F 5/0659

(57) ABSTRACT

Aspects of the went disclosure are directed to a mixing device having at least one gas-carrying gas duct, at least one injection device for injecting a liquid and at least one first guiding element positioned downstream of the at least one injection device and projecting into a gas flow in the at least one gas-carrying gas duct. The at least one gas-carrying gas duct having at least one bulge of a duct wall directly downstream of the at least one first guiding element.

The invention relates to a mixing device having at least one gas-carrying gas duct, wherein at least one injection device for injecting a liquid is associated with the mixing device and at least one first guiding element is arranged downstream of the injection device projecting into a gas flow of the gas duct.

Furthermore, the invention relates to a method for mixing gases or gas mixtures, wherein gas or the gas mixture is guided in at least one gas duct and a liquid is injected from an injection device into the gas duct, wherein the gas or the gas mixture is at least partially deflected downstream of the injection device by at least one first guiding element.

Mixing devices are used in mechanical engineering for various applications, e.g. for exhaust gas aftertreatment systems of internal combustion engines or, depending on the fuel, for preheating units in fuel cells. For exhaust gas aftertreatment, especially of internal combustion engines of vehicles, liquid additives are often used, which are injected into the exhaust duct to react with the exhaust gas. Urea solutions in particular have become established for the decomposition of nitrogenous compounds such as nitrogen oxides in connection with SCR catalytic converters (“selective catalytic reaction”) for the selective catalytic reaction of diesel exhaust gases. The optimal distribution of the additive in the exhaust gas, its mixing with the exhaust gas, and the prevention of deposits of the additive in the injected exhaust duct are of great importance. Particularly with urea solutions, there is a risk of urea crystallizing on the duct walls. This increases the flow resistance or the urea crystals can lead to damage in downstream components.

US 2015/0059319 A1 describes a mixing device in which guiding elements protrude into the exhaust duct downstream of an injection point. These serve to divert, swirl and mix the exhaust gas. The disadvantage, however, is that deposits of the additive can accumulate in the slipstream of the guiding elements, which cannot be removed again or can only be removed with difficulty, which can lead to solidification and crystallization of the additive on the duct wall.

US 2014/0230419 A1 teaches an alternative solution, which provides bulges in the duct walls, which are intended to cause mixing or swirling of the exhaust gas. However, the turbulence is often not strong enough to achieve optimum mixing of the exhaust gas or the exhaust gas with the additive. In addition, in the bulges that are not strongly flowed around and are therefore cool, deposits can occur which do not evaporate completely again.

It is therefore an object of the present invention to provide a mixing device or a method for the aftertreatment of exhaust gases which enables an improved mixing of gas or gas mixtures and of gas or gas mixtures with a liquid.

According to the invention, this object is solved by a mixing device mentioned above in that the gas duct directly downstream of the first guiding element has at least one bulge in the duct wall of the gas duct. In other words, at least part of the exhaust gas is additionally deflected in at least one bulge directly downstream of the first guiding element. This leads to a homogenization of the gas or gas mixture on the one hand and to a mixing with the injected liquid on the other hand.

The term “downstream” is to be understood here with regard to the direction of flow of a gas or gas mixture conducted in the gas duct when the mixing device is used as intended.

In the context of this disclosure, a “bulge” is understood to be a deformation of an outer wall of the gas duct that increases the diameter of the gas duct. A bulge thus extends—irrespective of the shape of the cross-section of the gas duct—radially outwards with respect to the gas duct.

“Directly” means an adjacent arrangement of the first guiding element and bulge, so that the bulge is directly adjacent to the first guiding element. This allows the gas or gas mixture to be additionally deflected, which generates turbulence in the gas flow and leads to better mixing. The first guiding element and the bulge form a circulation space in which at least part of the gas can circulate. This causes a counterflow along the bulge against the main flow direction of the gas and towards the first guiding element, whereby deposited liquid is directed onto the first guiding element.

In the case of an application of the mixing device according to the invention in an exhaust gas aftertreatment device of an internal combustion engine, the hot exhaust gas flows against the first guiding element, whereby a good heat transfer from the exhaust gas to the guiding element takes place and it is heated particularly well by the guiding element, which facilitates evaporation of the injected liquids or prevents or at least reduces deposition of the injected liquid. If the liquid does not evaporate completely, it can travel along the first guiding element to its edge, where it can be removed by the exhaust gas flow. Furthermore, the described arrangement achieves a high degree of mixing of the exhaust gas, which is an additional advantage.

It is particularly advantageous if at least part of the gas or gas mixture—e.g. the exhaust gas—can be swirled in the bulge. The turbulence causes the gas to be mixed within itself and the injected liquid to be distributed homogeneously over the gas and also optimizes the absorption of liquid deposited in the bulge.

The deposition of liquid on the first guiding element can be further reduced if gas or gas mixture flows around the first guiding element on both sides. This means that gas or gas mixture flows around both flow surfaces of the first guiding element, which is especially due to the deflection of the flow direction in the bulge.

It may be provided that, when viewed in projection to the main flow direction of the gas or gas mixture, the first guiding element covers the entire bulge or only partially covers it.

It is advantageous if at least one injection nozzle of the injection device is directed towards the first guiding element. In other words, at least part of the liquid is sprayed in the direction of the first guiding element, or the injection device is arranged so that the outlet direction of the injection nozzle is directed towards the first guiding element. It is therefore particularly advantageous if the injection device is part of the mixing device or if the first guiding elements are located within the injection and/or nozzle range of the injection device.

This further improves the distribution of the liquid. The liquid deposited on the upstream oriented surfaces of the first guiding element is quickly reabsorbed into the gas flow due to the strong flow around these surfaces.

In a preferred embodiment variant, it is provided that at least the first guiding element and the duct wall are made in one piece. This represents a stable and easy to manufacture design with a small number of individual parts. The part of the duct wall forming the bulge can first be manufactured together with the first guiding element and then connected to the rest of the duct wall, or the first guiding element can be subsequently inserted into the finished duct wall, e.g. welded in.

It is also advantageous if the bulge is at least partially spherical or cylindrical in shape. This favors the circulation of the flow within the bulge with all the advantages described above.

The flows of the gas or gas mixture can be further improved if the first guiding element has a concave curvature in relation to the bulge. In other words, the guiding element is curved away from the bulge and against the direction of flow. This allows the counterflow to be directed along the curvature of the first guiding element, which improves the transport of the still liquid deposits. A particularly large circulation space is formed by the curvature and the bulge.

In order to further improve mixing, it may be provided that at least two first guiding elements are provided, preferably at the same flow level, wherein a bulge of the duct wall is arranged directly downstream of each first guiding element, preferably one bulge of the duct wall being provided for each first guiding element. Favorably, three first guiding elements are provided, which are located at equal distances from one another along the circumference of the gas duct.

Flow height is understood to be a plane normal to the main flow direction of the gas, i.e. essentially a cross-section of the gas duct normal to the main flow direction or normal to a longitudinal axis of the gas duct. Especially if the first guiding elements are evenly distributed in the cross-section, a particularly homogeneous mixing can be guaranteed. In this sense, it is particularly advantageous if at least one injection nozzle (or an outlet direction of an injection nozzle) of the injection device is directed at each first guiding element.

It is also advantageous if the bulge has a first flow surface on its inner side and the guiding plate has a second flow surface on its side facing the bulge, wherein preferably the first flow surface and the second flow surface merge continuously into each other. The inside of the bulge means the section of the bulge where the diameter of the gas duct is larger than in the rest of the gas duct, as viewed in the direction of flow. This allows a good flow of the liquid on the surfaces and thus facilitates its transport to the first guiding element. This also prevents deposits in the area of the flow surfaces.

In an advantageous embodiment it is provided that the bulge extends over the entire inner circumference of the gas duct and/or that the first guiding element extends over the entire inner circumference of the gas duct. This enables a particularly uniform mixing of the gas or gas mixture with itself or with liquid. The recess can thereby change its shape along the duct wall of the gas guiding channel. The first guiding element can also change its shape along the inner duct wall of the gas duct.

To enable complete mixing of the gas or gas mixture, it is advantageous if the sum of the areas of the first guiding elements is at least 25% of the cross-sectional area of the gas duct when viewed in projection to a main flow direction of the gas. This achieves a high mixing effect between gas and liquid and prevents the gas, which is guided centrally in the gas duct, from being mixed with the remaining gas or the injected liquid. It is particularly advantageous if the sum of the areas of those first guiding elements, which are arranged at the same flow height, covers at least 25% of the cross-sectional area of the gas duct in projection to a main flow direction of the gas flowing in the gas duct.

To further enhance mixing, it may be provided that at least one second guiding element is arranged downstream of the first guiding element, wherein preferably the second guiding element is arranged directly downstream of the bulge. This results in a further improved mixing of gas and liquid. The second guiding element can be arranged or shaped in such a way that it influences the flows and turbulences induced by the first guiding element and the bulge or essentially does not affect them. In principle, further guiding elements can also be arranged upstream of the first guiding elements.

By placing the second guiding element directly downstream relative to the bulge, it can contribute to and reinforce the flow induced by the first guiding element and the bulge.

In one variant of the invention, at least one, preferably at least two concentrically arranged nozzle bodies is/are provided in the gas duct at the level of the bulge, which are preferably circularly symmetrical and/or concentrically arranged. The nozzle bodies, which are for example Laval nozzle-like, serve to reinforce or direct the flows and turbulences, wherein it is particularly advantageous if only a small distance is left between nozzle body and guiding element. With this embodiment, gas can be sucked through the space between the guiding element and the nozzle body from the region between the bulge and the first guiding element, thus increasing the circulation flow.

Two or more nozzle bodies can be arranged concentrically, but it is also conceivable that several nozzle bodies are arranged behind or next to each other.

The object of the invention is further solved by the method mentioned above, wherein according to the invention at least a part of the gas or gas mixture is additionally deflected in at least one bulge directly downstream of the first guiding element.

Favorably, at least part of the gas or gas mixture is swirled in the bulge.

In one variant of the invention, at least part of the liquid is sprayed in the direction of the first guiding element. Conveniently, the gas or the gas mixture flows around both sides of the first guiding element.

In the following, the present invention is explained in more detail on the basis of the non-restrictive embodiment variants shown in the figures, wherein:

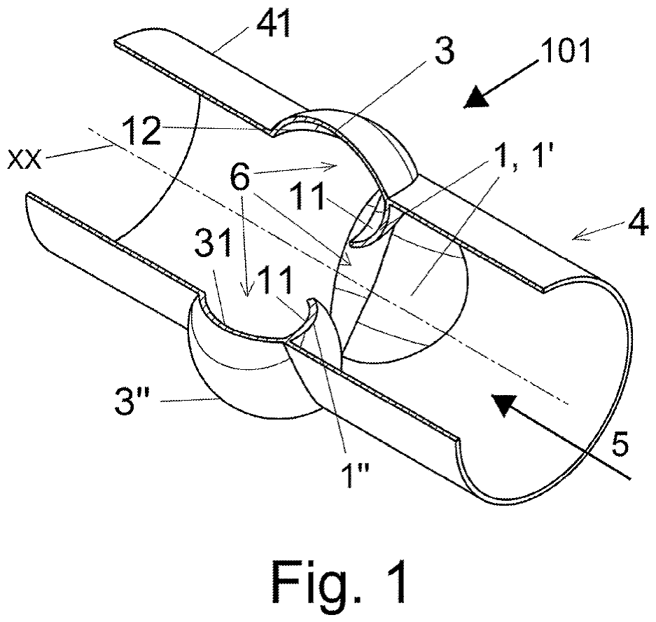

FIG. 1 shows a part of a mixing device according to the invention in a first embodiment in a partially sectional oblique view;

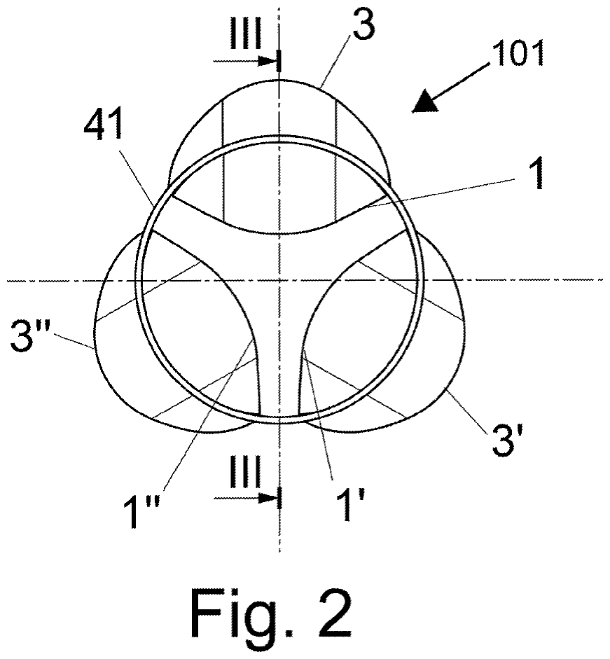

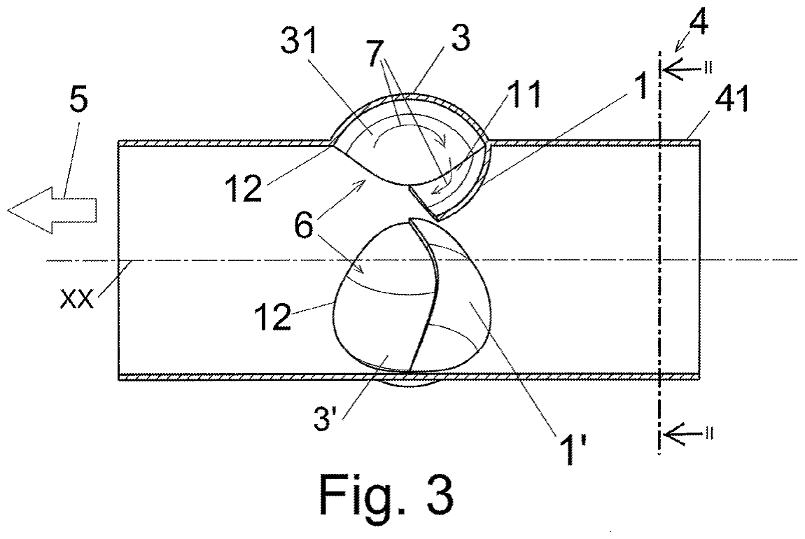

FIG. 2 shows a view of the first embodiment in a cross-section along line II-II in FIG. 3;

FIG. 3 shows the part of the first embodiment in a longitudinal section along line III-III in FIG. 2;

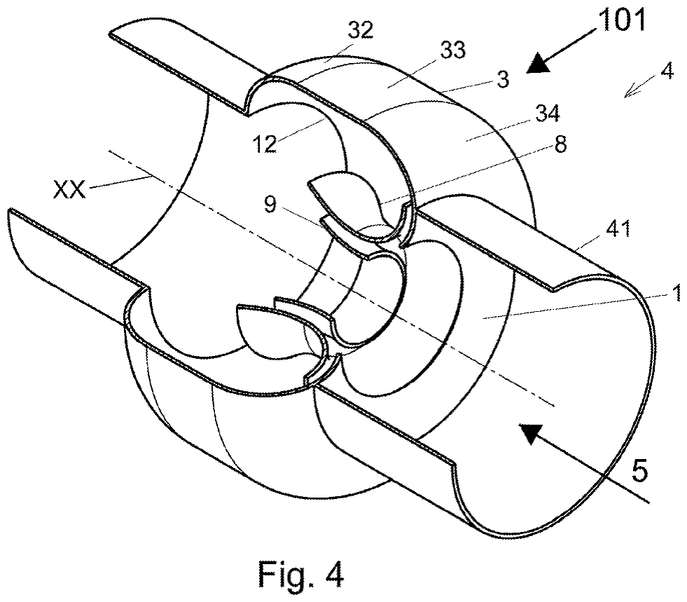

FIG. 4 shows a part of a mixing device according to the invention in a second embodiment in a partially sectional oblique view;

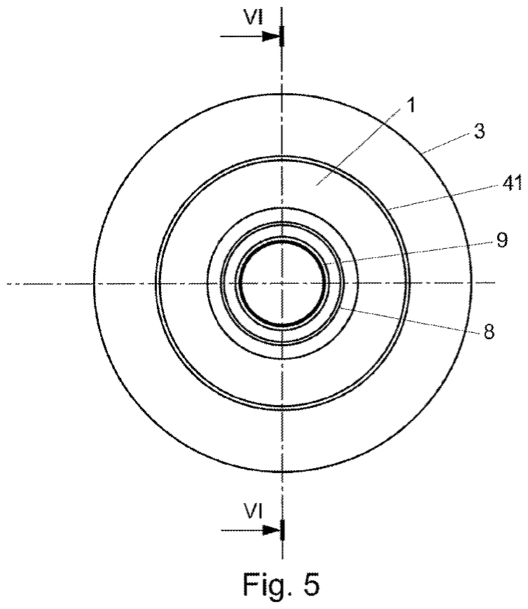

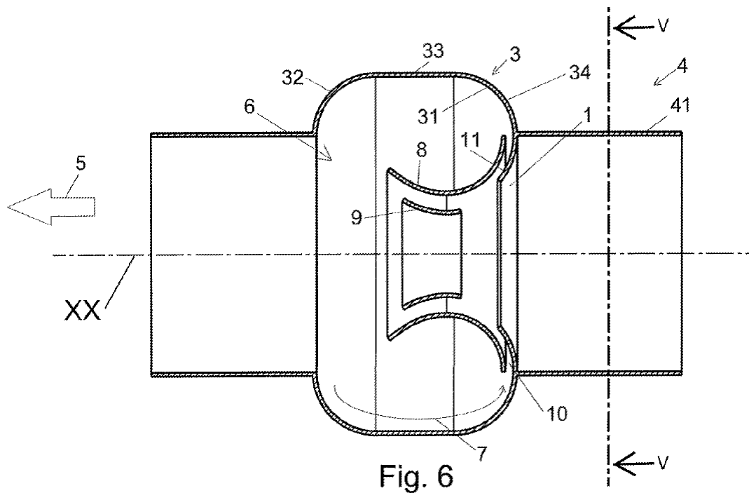

FIG. 5 shows the part of the second embodiment from FIG. 4 in a cross-section along the line V-V in FIG. 6;

FIG. 6 shows the part of the second embodiment in a longitudinal section along line VI-VI in FIG. 5;

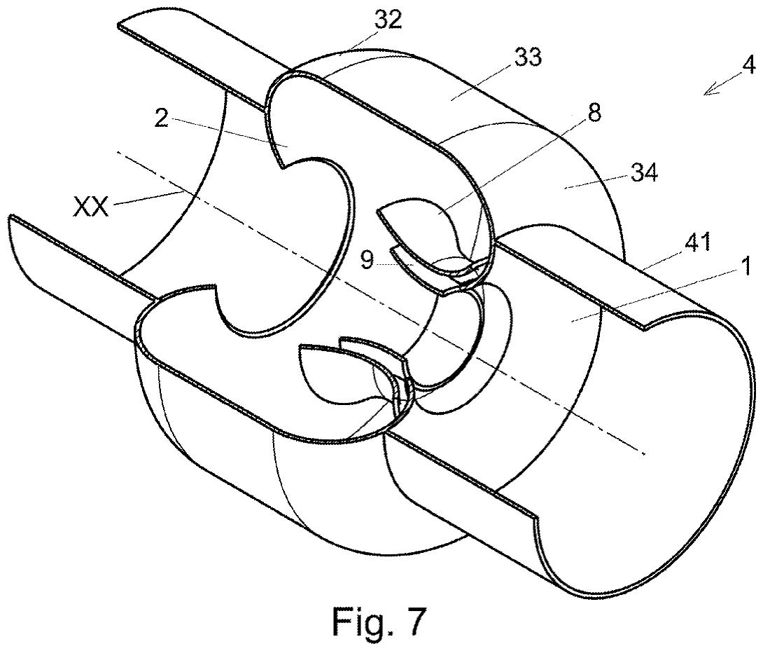

FIG. 7 shows a part of a mixing device according to the invention in a third embodiment of a partially sectional gas duct in an oblique view;

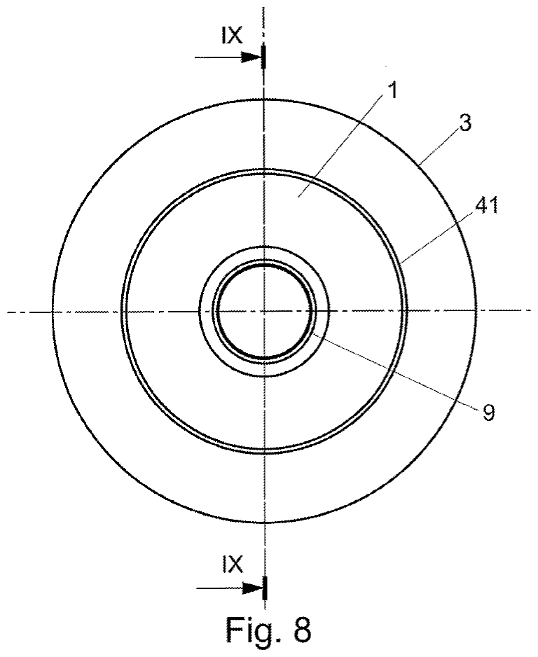

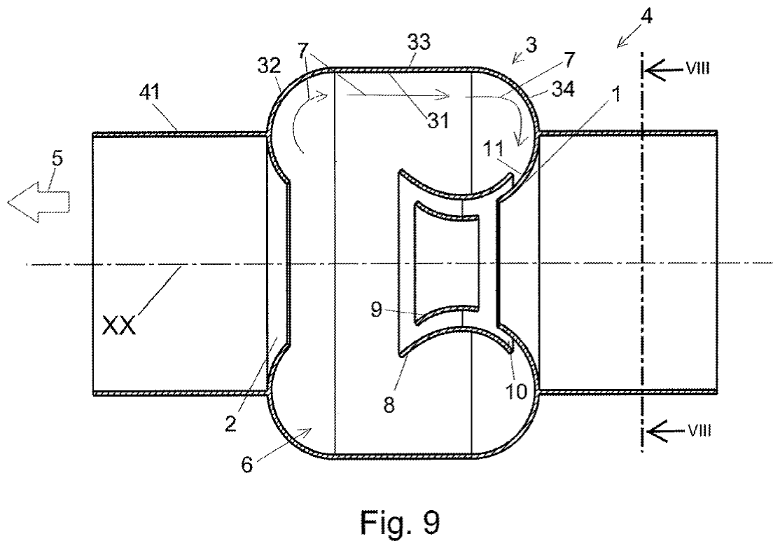

FIG. 8 shows the part of the third embodiment in a cross-section along line VIII-VIII in FIG. 9;

FIG. 9 shows the part of the third embodiment in a longitudinal section along line IX-IX in FIG. 8;

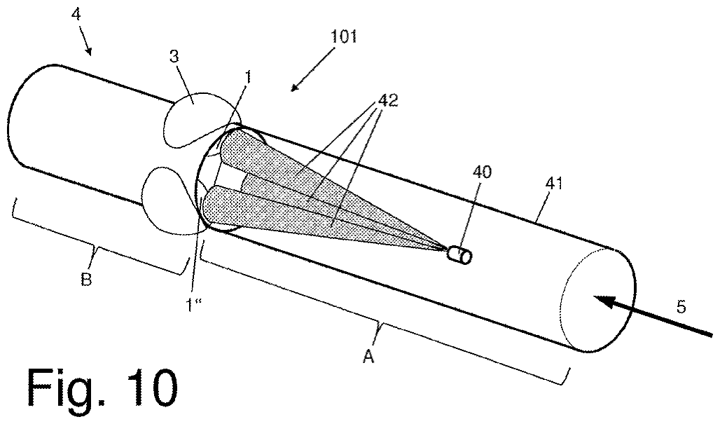

FIG. 10 shows a part of a mixing device according to the invention in a fourth embodiment in a partially sectional or transparent oblique view, and

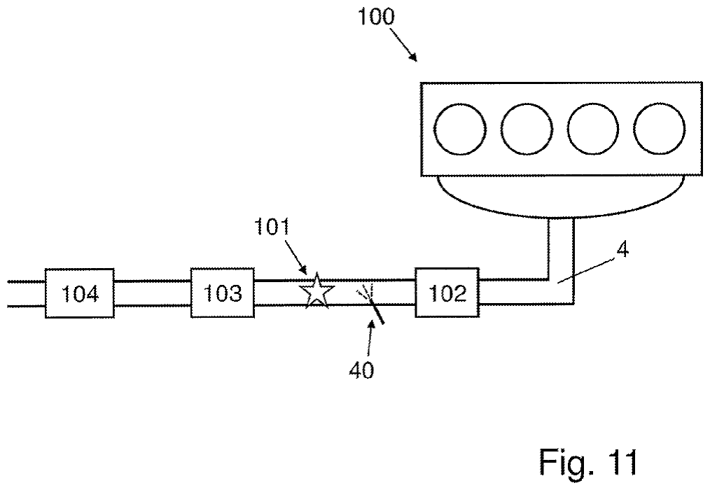

FIG. 11 shows a schematic view of an internal combustion engine with an exhaust aftertreatment device with mixing device according to the invention.

In the following, the advantages of the mixing device or the method according to the invention are explained in a possible application in an exhaust aftertreatment device of an internal combustion engine. As mentioned initially, use in other arrangements, e.g. in fuel cells, is also possible.

FIG. 11 therefore shows a section of an internal combustion engine 100 with a gas duct designed as exhaust duct 4 with an exhaust gas aftertreatment device with a mixing device 101 according to the invention. In the following, the gas duct will be designated with the term exhaust duct and the reference numeral “4”. The gas or gas mixture flowing in the gas duct is exhaust gas.

The exhaust gas aftertreatment device has a number of exhaust gas aftertreatment elements 102, 103, 104, which may be designed as SCR, DOC, LNT, sDPF, DPF or other components, for example, and are arranged one after the other in the direction of flow of the exhaust gas. An injection device 40 is arranged upstream of the mixing device 101 according to the invention, with which a liquid in the form of an additive—e.g. a reducing agent such as a urea or urea solution—can be introduced into exhaust duct 4.

In FIG. 1, FIG. 2 and FIG. 3 a first embodiment example of the mixing device 101 according to the invention is shown with a total of three first guiding elements 1, 1′, 1″ and three bulges 3, 3′, 3″ of a duct wall 41 of an exhaust duct 4 through which exhaust gas flows, wherein the first guiding elements 1, 1′, 1″ are arranged downstream of an injection device that is not shown. The main flow direction 5 of the exhaust gas is shown by an arrow. The first guiding elements 1, 1′, 1″ and the bulges 3, 3′, 3″ are shown in a partial section for better visibility. In the area of the bulges 3, 3′, 3″, the diameter of the exhaust duct 4 is larger than before and after. In the area of the bulges 3, 3′, 3″, the duct wall 41 of the exhaust duct 4 widens in radial direction away from a longitudinal axis XX of the exhaust duct 4.

The first guiding elements 1, 1′, 1″ are arranged at the boundary edges 12 of the bulges 3, 3′, 3″ on their upstream sides and are thus directly adjacent to them. The exhaust gas duct 4 is designed as an essentially round pipe with the three bulges 3, 3′, 3″ and thus defines a main flow direction 5 of the exhaust gas, along the longitudinal extension of the exhaust gas duct 4. It is understood that the invention can also be implemented in gas ducts with other cross-sections.

The first guiding elements 1, 1′, 1″ are located at the same height of the exhaust duct 4 and thus at the same flow level. They are welded onto the duct wall 41 and thus connected to it in one piece. The bulges 3, 3′, 3″ are at least partially spherical or cylindrical, have the shape of spherical segments and have essentially continuous first flow surfaces 31, which extend over the entire inner sides of the parts of the duct wall 41 that form the bulges 3, 3′, 3″. The first guiding elements 1, 1′, 1″ are concave curved with respect to the bulges 3, 3′, 3″ and completely cover the upstream sides of the bulges 3, 3′, 3″. Thus, the exhaust gas must first flow past the first guiding elements 1, 1′, 1″ before it can flow into the bulges 3, 3′, 3″. The first guiding elements 1, 1′, 1″ have essentially continuous second flow surfaces 11, which extend over the entire sides of the first guiding elements 1, 1′, 1″ facing the bulges 3, 3′, 3″. The first flow surfaces 31 and second flow surfaces 11 adjoin one another, wherein they do not merge continuously into one another, but have a kink edge. As a result of this embodiment, partially open circulation spaces 6 are formed by the bulges 3, 3′, 3″ and the first guiding elements 1, 1′, 1″, in which a backflow 7 can occur, which conveys exhaust gas of the first and second flow surfaces 31, 11 from the downstream side of the bulge 3, 3′, 3″ to the upstream side of the bulge 3, 3′, 3″ and along the downstream side of the first guiding elements 1, 1′, 1″. This causes, on the one hand, a flow around the downstream side of the first guiding element 1, 1′, 1″ and, on the other hand, swirling of the exhaust gas. In FIG. 2, it can be seen that the sum of the areas of the first guiding elements 1 viewed in projection to the main flow direction 5 is over at least 50% of the cross-sectional area of the exhaust gas duct 4.

FIG. 4, FIG. 5 and FIG. 6 show a second embodiment which has only one annular first guiding element 1 and a single toroidal bulge 3. The first guiding element 1 and the bulge 3 extend over the entire inner circumference of the exhaust gas duct 4. The bulge 3 has a substantially cylindrical central segment 33 and curved segments 32, 34 at its ends, which in cross-section essentially have the shape of a circular segment. The first guiding element 1 is designed as an extension of the upstream curved segment 34 which projects into the interior of the exhaust duct 4 and tapers towards the bulge 3. This has the advantage on the one hand that the first flow surface 31 and the second flow surface 11 thus merge continuously into one another and on the other hand that the part of the duct wall 41 forming the bulge 3 can be manufactured in one piece together with the first guiding element 1 and be subsequently connected to the upstream and downstream part of the duct wall 41. This represents an embodiment variant that is particularly easy to manufacture.

This defines a large circulation space 6 in which a backflow 7 in the downstream areas of the bulge 3 extends from the center of the exhaust duct 4 in the direction of the duct wall 41, against the main flow direction 5 along the duct wall 41 and on the upstream side of the bulge 3 and the downstream side of the first guiding element 1 into the center of the exhaust duct 4. Two ring-shaped nozzle bodies 8, 9 concentrically arranged one inside the other are arranged at the height of the bulge 3, at a distance from the first guiding element 1. In particular, the nozzle bodies 8, 9 are circularly symmetrical and concentrically arranged with respect to a longitudinal axis XX of the exhaust duct 4.

They are also concave in relation to the duct wall 41 and the outer nozzle body 8 protrudes over the first guiding element 1 on its downstream side. This results in a passage gap 10, whereby the first guiding element 1 and the outer nozzle body 8 act as a venturi nozzle and draw exhaust gas from the upstream part of the bulge 3. This increases the backflow 7 and thus the mixing and turbulence. The downstream parts of the Laval-type nozzle bodies 8, 9 are curved towards the bulge 3 and direct the exhaust gas from the center of the exhaust duct 4 towards the duct wall 41 of the exhaust duct 4, which also contributes to the backflow 7.

FIG. 7, FIG. 8 and FIG. 9 show a third embodiment, which is similar to the second embodiment, but here a ring-shaped second guiding element 2 is provided, which is arranged at the downstream edge of the bulge 3. Like the first guiding element 1, the second guiding element 2 is also made in one piece and is designed as an extension of the part of the duct wall 41 which forms the bulge 3, projecting into the interior of the bulge 3. “Projecting into the interior” here means that the second guiding element 2 extends along the longitudinal axis XX into the area of the bulge 3. This makes this section particularly easy to produce. It has a concave curvature in relation to the bulge 3, as a result of which the first guiding element 1 and the second guiding element 2 are inclined towards each other. This further increases the backflow 7 in the area of the bulge 3.

FIG. 10 shows an embodiment of the invention, where the mixing device 101 with an associated injection device 40 is shown in a section of an exhaust duct 4. The injection device 40 is used for injecting a liquid, in the case of an exhaust aftertreatment device, e.g. a liquid additive. In the illustration according to FIG. 10, the injection device 40 is part of the mixing device 101, but in other exemplary embodiments it can also be positioned further away.

In FIG. 10, the exhaust duct 4 is shown in a sectional view in a first section A, in a section B the exhaust duct is only visible from the outside.

In FIG. 10, the injection device 40 is located in the exhaust duct 4 upstream of the three bulges 3, 3′, 3″ and has three injection nozzles. The outlet direction of each nozzle faces in the direction of a first guiding element 1, 1″ and sprays a liquid additive in a spray cone 42 which widens in the spraying direction. If additive is deposited on the first guiding elements 1, 1″, it is immediately absorbed by the exhaust gas flowing past or transported through the curved shape of the first guiding elements 1, 1″ at their edges where it is entrained by the exhaust gas.

As has been shown on the basis of the application in an exhaust gas aftertreatment device of an internal combustion engine 100, in a method for mixing gases or gas mixtures according to the invention, the gas or gas mixture is guided in at least one gas duct 4 and a liquid from an injection device 40 is injected into the gas duct 4, wherein the gas or the gas mixture is at least partially deflected downstream of the injection device 40 by at least one first guiding element 1, 1′, 1″. At least part of the gas or gas mixture is additionally deflected or swirled in at least one bulge 3, 3′, 3″ directly downstream of the first guiding element 1, 1′, 1″. At least part of the liquid—in the case of an exhaust gas aftertreatment device a urea or urea solution or another suitable additive—is sprayed or injected in the direction of the first guiding element 1, 1′, 1″. If gas or the gas mixture—in particular hot exhaust gas in the case of an exhaust aftertreatment device—flows around both sides of the first guiding element 1, 1′, 1″, the deposition of liquid can be prevented.

1. Mixing device comprising:
at least one gas-carrying gas duct;
at least one injection device configured and arranged to inject a liquid into the at least one gas duct;
at least one first guiding element, positioned downstream of the at least one injection device is configured and arranged to project into a gas flow of the at least one gas duct; and
wherein the at least one gas duct has at least one bulge of a duct wall directly downstream of the at least one first guiding element.

2. The mixing device according to claim 1, wherein the at least one injection device includes at least one injection nozzle directed towards the at least one first guiding element.

3. The mixing device according to claim 1, characterized in that at least the at least one first guiding element and the duct wall are made in one piece.

4. The mixing device according to claim 1, characterized in that the at least one bulge has at least partially a spherical or cylindrical shape.

5. The mixing device according to claim 1, characterized in that the at least one first guiding element has a concave curvature with respect to the at least one bulge.

6. The mixing device according to claim 1, wherein the at least one first guiding element includes at least two first guiding elements wherein a bulge of the duct wall is arranged directly downstream of each of the at least two first guiding elements.

7. The mixing device according to claim 1, characterized in that the at least one bulge has a first flow surface on its inside, and the at least one first guiding element has a second flow surface on its side facing the bulge.

8. The mixing device according to claim 1, characterized in that the at least one bulge extends over the entire inner circumference of the at least one gas duct and/or in that the at least one first guiding element extends over the entire inner circumference of the at least one gas duct.

9. The mixing device according to claim 1, characterized in that, when viewed in projection to a main flow direction of the gas within the mixing device, the sum of the areas of the at least one first guiding elements is at least 25% of the cross-sectional area of the at least one gas duct.

10. The mixing device according to claim 1, further including at least one second guiding element arranged downstream of the at least one first guiding element.

11. The mixing device according to claim 1, characterized in that at the level of the at least one bulge at least one nozzle body is provided in the at least one gas duct.

12. Method for mixing gases or gas mixtures including the steps of:
guiding the gas or the gas mixture via at least one gas duct,
injecting a liquid into the at least one gas duct from an injection device,
deflecting, at least partially, the gas or gas mixture downstream of the injection device by at least one first guiding element, and
additionally deflecting at least part of the gas or gas mixture in at least one bulge directly downstream of the first guiding element.

13. The method according to claim 12, characterized in that at least a part of the gas or gas mixture is swirled in the at least one bulge.

14. The method according to claim 12, characterized in that at least a part of the liquid is sprayed in the direction of the first guiding element.

15. The method according to claim 12, characterized in that gas or the gas mixture flows around the first guiding element on both sides.

16. The mixing device of claim 6, wherein the at least two first guiding elements are provided at the same flow level, and wherein one bulge is provided for each first guiding element.

17. The mixing device of claim 7, wherein the first flow surface and the second flow surface merge continuously into one another.

18. The mixing device of claim 10, wherein the at least one second guiding element is arranged directly downstream of the at least one bulge.

19. The mixing device of claim 11, wherein, at the level of the at least one bulge, at least two concentrically arranged nozzle bodies are provided in the at least one gas duct, and which are formed in a circularly symmetrical manner and/or concentrically arranged.
